(19) United States
(12) Patent Application Publication
(10) Pub. No.: US 2012/0028565 A1
(43) Pub. Date: Feb. 2, 2012

(54) OBJECTS HAVING AT LEAST ONE OPENING COVERED BY A MEMBRANE, AND METHOD FOR PRODUCTION THEREOF

(75) Inventors: Carl Jokisch, Mannheim (DE); Juergen Weiser, Schriesheim (DE)

(73) Assignee: BASF SE, Ludwigshafen (DE)

(21) Appl. No.: 13/123,782

(22) PCT Filed: Oct. 9, 2009
(86) PCT No.: PCT/EP2009/063132

§ 371 Date: Apr. 12, 2011

(30) Foreign Application Priority Data
Oct. 15, 2008 (EP) 08166642.2

(51) Int. Cl. F24F 7/00; B32B 37/12; B32B 3/24

(52) U.S. Cl. 454/284; 428/138; 156/242

(57) ABSTRACT

An article having at least one opening wherethrough an air stream is directed, said opening being covered on the face side by a visually appealing air-permeable or breathable membrane wherethrough the gas stream passes, said membrane comprising two or more layers, one of which comprising at least one polyurethane and exhibiting patterning.

The present invention provides an article having at least one opening wherethrough an air stream is directed, said opening being covered on the face side by a visually appealing air-permeable or breathable membrane wherethrough the gas stream passes, said membrane comprising two or more layers, one of which comprising at least one polyurethane and exhibiting patterning.

The present invention further provides a process for producing articles which are in accordance with the present invention.

Numerous articles have openings through which an air stream is passed. Examples are air conditioning systems, heating systems, in particular in vehicles, and fans. The openings usually do not have an aesthetic appearance. In addition, in most cases, a fast air stream is blown into the space in question, which people perceive as unpleasant (“draft”). The consequences in the worst case may be illnesses such as for example conjunctivitis, stiffness, in particular a “stiff neck”, or rheumatism.

Prior art solutions, for example that the air stream be passed through an open-cell foamed plastic, have not successfully solved either the aesthetic problem or the draft problem.

It is an object of the present invention to provide articles having at least one opening wherethrough an air stream is passed that combine a pleasant appearance with the property that the air stream is not directly directed onto people and therefore perceived as unpleasant.

We have found that this object is achieved by the articles defined at the beginning.

Articles in accordance with the present invention may comprise any desired materials, for example wood, stone, concrete, glass, metal, plastic, particularly thermoplastics and thermosets.

In one embodiment of the present invention, article in accordance with the present invention comprises a constituent part of a vehicle. The article in accordance with the present invention preferably comprises a formed part, for example of a cabin interior lining of ships or airplanes, dashboards of a motor vehicle, of an airplane, of a train or of a water vehicle, also center consoles or side rails of motor vehicles. Examples of motor vehicles are trucks, lorries, buses, coaches and particularly passenger cars.

In another embodiment of the present invention, articles in accordance with the present invention are selected from interior parts of buildings, in particular from walls and wall coverings.

In one embodiment of the present invention, article in accordance with the present invention comprises an air conditioning system, a heating system or a fan. The identity of the air conditioning system, heating system or the fan is immaterial.

The at least one opening may comprise openings of any desired shape and size. Suitable are circular, rectangular, trapezoidal, parallelogramic, rhombic or slot-shaped openings, but also ellipsoidal or irregularly shaped openings. The diameter is freely choosable; the diameter is preferably in the range from 1 mm to 10 cm.

An air stream is directed through the opening, permanently or preferably temporarily. The air stream may be temperature conditioned and preferably is temperature conditioned, comprising for example warm air or cooled air.

In one embodiment of the present invention, the air stream may comprise moisture or one or more scents.

In one embodiment of the present invention, the air stream comprises dried air.

At least one opening in article which is in accordance with the present invention is covered on the face side by a visually appealing air-permeable or breathable membrane.

In one embodiment of the present invention, said opening or openings is or are covered by said membrane such that it or they—when viewed from said face side—is or are not recognizable as an opening.

Covered herein is to be understood as meaning that the membrane is placed over the opening or openings partially or preferably completely, so that the opening in question is as such withdrawn from the gaze of the observer at least partially, but preferably completely. The membrane may preferably be bonded by means of attachment techniques to the article which is in accordance with the present invention, particularly by adhering, needling or tacking and most preferably by inter-adhering.

In one embodiment of the present invention, the article which is in accordance with the present invention includes two or more openings through each of which an air stream is directed, and at least one or preferably all of these openings are covered by a visually appealing air-permeable or breathable membrane.

In another embodiment of the present invention, the article which is in accordance with the present invention includes two or more openings through each of which an air stream is directed, and at least one or more of these openings are covered by a visually appealing air-permeable or breathable membrane but at least one opening is not.

The face side of the article which is in accordance with the present invention is that side which the observer typically looks at when the article which is in accordance with the present invention is put to its intended use.

Visually appealing may apply to a patterned surface, a nonpatterned surface, a colored surface or noncolored surface.

In one particular embodiment, the surface of articles which are in accordance with the present invention further comprises logos, monograms or script.

In one embodiment of the present invention, the membrane has on its face side a leatherlike appearance, preferably the appearance of a grain leather or of a nubuck leather.

In one embodiment of the present invention, the membrane has on its face side a pleasant haptic profile, for example of a leather, particularly of a nubuck leather.

The membrane is breathable, i.e., air permeable and/or water vapor permeable. This is to be understood as meaning that the water vapor transmission rate of the membrane is above 1.5 mg/cm²·h, measured to German standard specification DIN 53333.

In one embodiment of the present invention, the measurement of the water vapor transmission rate is carried out using an air-permeability measuring system of the APMS/D120R-1 type from IMAK GmbH of Ingolstadt. For the purpose of the measurement, a substrate, for example a finished leather, is clamped between two pressure chambers. Both the chambers are pressurized. After one chamber has been decompressed, the time needed for the system to equilibrate within certain pressure ranges is measured.

Articles which are in accordance with the present invention require for example less than 60 seconds to equalize a pressure difference of 0.5 bar to 0.01 bar at a sample diameter of 120 mm. Preference is given to just 10 seconds and particular preference to just 1 second.

The membrane comprises two or more layers, of which at least one comprises a polyurethane and exhibits patterning. This layer will hereinafter also be referred to in brief as “polyurethane layer”.

In an embodiment of the present invention, polyurethane layer has an average thickness in the range from 15 to 300 μm, preferably in the range from 20 to 150 μm, and more preferably in the range from 25 to 80 μm.

In one embodiment of the present invention, the membrane of the article which is in accordance with the present invention comprises two different polyurethanes: polyurethane (PU1) and polyurethane (PU2), of which polyurethane (PU1) is a so-called soft polyurethane and at least one hard polyurethane (PU2). Hard and soft polyurethanes are described hereinbelow.

The membrane may comprise two, three or four layers for example. The additional layers must not impair the air permeability or breathability to such an extent that the air stream can no longer pass through the membrane.

In one embodiment of the present invention, the membrane comprises at least one backing material as one of the layers. The backing material or materials is or are air permeable/breathable, and the layer composed of polyurethane may cover the backing material or materials completely or partially. It is also conceivable that when the membrane comprises two or more backing materials the polyurethane layer covers backing material 1 in some places and backing material 2 in other places.

In one embodiment of the present invention, the backing material or backing materials are independently selected from leather, split leather, artificial leather, bonded leather, cellulosic materials such as for example paper, also textile and open-cell foamed plastics.

Textile can have various forms of manifestation. Suitable are for example wovens, felt, knits, waddings, laid scrims and microfiber fabrics, also non-wovens.

Textile may be selected from lines, cords, ropes, yarns or threads. Textile may be of natural origin, for example cotton, wool or flax, or synthetic, for example polyamide, polyester, modified polyesters, polyester blend fabrics, polyamide blend fabrics, polyacrylonitrile, triacetate, acetate, polycarbonate, polyolefins such as for example polyethylene and polypropylene, polyvinyl chloride, also polyester microfibers and glass fiber fabrics. Very particular preference is given to polyester, cotton and polyolefins such as for example polyethylene and polypropylene and also selected blend fabrics selected from cotton-polyester-cotton blend fabric, polyolefin-polyester blend fabric and polyolefin-cotton blend fabric.

Textile preferably comprises non-wovens, wovens or knits.

Textile may be untreated or treated, for example bleached or dyed. Preferably, textile is coated on one side only or uncoated.

Textile may be finished; in particular textile may have an easy care and/or flame-retardant finish.

Textile may have an areal weight in the range from 10 to 500 g/m², and preferably in the range from 50 to 300 g/cm².

Cellulosic material may comprise various species of cellulosic materials. Cellulosic in the context of the present invention includes hemicellulosic and lignocellulosic.

Cellulosic material may preferably comprise paperboard, cardboard, chemical pulp or particularly paper. Paper for the purposes of the present invention may be uncoated or preferably coated or conventionally finished. More particularly, paper may comprise bleached paper. Paper may comprise one or more pigments, for example chalk, kaolin or TiO₂, and paper, paperboard or cardboard may be undyed (ecru in color) or colored. Paper, paperboard and cardboard for the purposes of the present invention may be printed or unprinted.

In one embodiment of the present invention, paper may comprise craft paper.

In one embodiment of the present invention, paper may comprise paper finished with polyacrylate dispersion.

Leather herein comprises tanned animal hides, which may be finished or preferably nonfinished. Tanning may be done according to a wide variety of methods, for example with chrome tannins, other mineral tannins such as for example aluminum compounds or zirconium compounds, with polymeric tannins, for example homo- or copolymers of (meth)acrylic acid, with aldehydes, in particular with glutaraldehyde, with synthetic tannins such as for example condensation products of aromatic sulfonic acids with aldehydes, in particular formaldehyde, or with other carbonyl-containing compounds such as for example condensation products of aromatic sulfonic acids with urea. Further suitable leathers are leathers tanned with vegetable tannins and/or enzymatically. Leathers tanned with a mixture of two or more of the aforementioned tannins are also suitable.

Leather herein may further have undergone one or more of the operations known per se, for example hydrophobicization, fatliquoring, retanning and dyeing. Leather may be obtained for example from hides of cattle, hogs, goats, sheep, fish, snakes, wild animals or birds.

Leather may have a thickness in the range from 0.2 to 2 mm. Leather preferably comprises grain leather. Leather can be free of raw hide defects, but such leather which includes raw hide defects, caused for example by injuries due to barbed wire, fights between animals or insect bites, is also suitable.

In one embodiment of the present invention, leather comprises split leather, or split.

In one embodiment of the present invention, leather comprises suede leather or split suede.

In one embodiment of the present invention, backing comprises artificial leather. Artificial leather herein also comprises precursors to artificial leather, specifically those where the uppermost layer, i.e., a or the top layer, is missing. Artificial leather herein comprises plastic-coated, preferably textile sheetlike bodies with or without top layer, the top layer, if present, having a leatherlike appearance. Examples of artificial leather are artificial leather based on woven fabric, artificial leather based on non-woven fabric, artificial leather based on fiber, artificial leather based on foil and artificial leather based on foam. The term artificial leather also covers articles having two top layers such as for example artificial leather based on non-woven fabric. Particularly preferred artificial leathers are breathable artificial leathers based on polyurethane, as described for example in Harro Träubel, New Materials Permeable to Water Vapor, Springer Verlag 1999. Preference is further given to backing materials wherein an open-cell polyurethane foam is applied to a textile backing, for example as a beaten foam or by direct in-situ foaming.

Examples of open-cell foamed plastics are polyurethanes and aminoplast foams, in particular melamine foams. In the context of the present invention, “open-cell” is to be understood as meaning that in the foams in question at least 50% of all lamellae are open, preferably 60 to 100% and more preferably 65 to 99.9%, determined to German standard specification DIN ISO 4590.

In one embodiment of the present invention, the air permeability/breathability of the polyurethane layer of the membrane is based largely or substantially on pores which extend through the entire thickness of the polyurethane layer.

The pores may be configured as capillaries for example. In one embodiment of the present invention, polyurethane layer has on average at least 100 and preferably at least 250 capillaries per 100 cm².

In one embodiment of the present invention, the capillaries have an average diameter in the range from 0.005 to 0.05 mm and preferably in the range from 0.009 to 0.03 mm.

In one embodiment of the present invention, the capillaries are uniformly distributed over the polyurethane layer. In a preferred embodiment of the present invention, however, the capillaries are nonuniformly distributed over the polyurethane layer.

In one embodiment of the present invention, the capillaries are substantially arcuate. In another embodiment of the present invention, the capillaries have a substantially straight-line course.

The capillaries endow the polyurethane layer with a permeability to air and water vapor without any need for aperturing.

In one embodiment of the present invention, polyurethane layer and backing material are linked to each other through at least one bonding layer, which bonds polyurethane layer and backing material together, for example adhesively, uniformly or only partially. Yet the bonding layer must not impair the air permeability/breathability. It is thus possible for example to produce a bonding layer by applying an adhesive to the respective reverse side of polyurethane layer and/or backing material in the form of patterns or very thin films and then to place, for example press, polyurethane layer and backing material onto each other.

Bonding layer may comprise an interrupted, i.e., nonuniformly formed, layer, preferably of a cured organic adhesive.

In one embodiment of the present invention, bonding layer comprises a layer applied in point form, stripe form or lattice form, for example in the form of diamonds, rectangles, squares or a honeycomb structure. In that case, polyurethane layer comes into contact with the backing material at the gaps in the bonding layer.

In one embodiment of the present invention, at least one bonding layer comprises a layer of a cured organic adhesive, for example on the basis of polyvinyl acetate, polyacrylate or particularly polyurethane, preferably of polyurethanes having a glass transition temperature below 0° C.

The organic adhesive may be cured for example thermally, through actinic radiation or by aging.

In another embodiment of the present invention, at least one bonding layer comprises an adhesive gauze.

In one embodiment of the present invention, the bonding layer has a maximum thickness of 100 μm, preferably 50 μm, more preferably 30 μm, most preferably 15 μm.

In one embodiment of the present invention, bonding layer may comprise micro-balloons. Microballoons herein are spherical particles having an average diameter in the range from 5 to 20 μm and composed of polymeric material, in particular of halogenated polymer such as for example polyvinyl chloride or polyvinylidene chloride or copolymer of vinyl chloride with vinylidene chloride. Microballoons may be empty or preferably filled with a substance whose boiling point is slightly lower than room temperature, for example with n-butane and in particular with isobutane.

In one embodiment of the present invention, the polyurethane layer may be bonded to the backing material via at least two bonding layers having the same or a different composition. One bonding layer may comprise a pigment with the other bonding layer being pigment free.

In one variant, one bonding layer may comprise microballoons and the other bonding layer not comprising microballoons.

In one particular embodiment, the polyurethane layer is bonded to the backing material without a bonding layer.

In one embodiment of the present invention, the patterning on the polyurethane layer is produced by a coating process, in particular by a reverse coating process.

In one embodiment of the present invention, the patterning on the polyurethane layer is produced with the aid of a mold. One possible procedure is for example to produce—by negative-molding for example—a mold having a negative version of the desired pattern, applying a preferably aqueous dispersion or emulsion of polyurethane thereto, removing water, preferably by evaporation, and then bonding the resulting polyurethane film to the backing material. The membrane having the desired patterning is obtained.

In one embodiment of the present invention, the patterning of the polyurethane layer corresponds to the patterning of a leather or of a wooden surface. In one embodiment of the present invention, the patterning can reproduce a nubuck leather.

In one embodiment of the present invention, the polyurethane layer has a velvetlike appearance.

In one embodiment of the present invention, the patterning may correspond to a velvet surface, for example with small hairs having an average length of 20 to 500 μm, preferably 30 to 200 μm and more preferably 60 to 100 μm. The small hairs may for example have a circle-shaped diameter. In a particular embodiment of the present invention, the hairs have a cone-shaped form.

In one embodiment of the present invention, the polyurethane layer has small hairs which are positioned relative to each other at an average separation of 50 to 350 and preferably 100 to 250 μm. When the polyurethane layer has small hairs, the statements about the average thickness relate to the polyurethane layer without the small hairs.

In many cases—for example when the polyurethane layer has a velvetlike appearance—the polyurethane layer also has very pleasant haptics.

The present invention further provides a process for producing articles which are in accordance with the present invention, herein also referred to as inventive production process. In one embodiment of the present invention, the inventive production process comprises the steps of:

(A) using a mold to produce a porous membrane exhibiting patterning,
(B) fixing said membrane to a backing material, and
(C) covering at least one opening in the article.

In one embodiment of the inventive production process, said fixing in step (b) is effected by applying at least one bonding layer to said membrane and/or said backing material.

One embodiment of the inventive production process proceeds by forming a polyurethane layer with the aid of a mold, applying at least one organic adhesive uniformly or partially to backing material and/or to the polyurethane layer and then bonding the polyurethane layer pointwise, stripwise or areawise to backing material.

In one embodiment of the present invention, porous membrane fixed to a backing material is produced by a coating process by first providing a polyurethane film, coating at least one backing material or the polyurethane film or both with organic adhesive on one face in each case, partially, for example in the form of a pattern, and then bringing the two faces into contact with each other. Thereafter, the system thus obtainable can additionally be pressed together or thermally treated or pressed together while being heated.

In one particular embodiment, a polyurethane layer is produced on a mold and then brought into contact directly with a backing material. For example, polyurethane layer can be directly back-foamed with a flexible foam or blade-coated with a mechanical foam.

The polyurethane film forms the later polyurethane layer of the membrane. The polyurethane film can be produced as follows:

An aqueous polyurethane dispersion is applied to a mold, which is preheated, the water is allowed to evaporate and then the resulting polyurethane film is transferred to the backing material in question.

Aqueous polyurethane dispersion can be applied to the mold by conventional methods, in particular by spraying, for example with a spray gun.

The mold may exhibit patterning, also referred to as structuring, for example produced by laser engraving or by molding with a negative mold.

One embodiment of the present invention comprises providing a mold having an elastomeric layer or a layer composite, comprising an elastomeric layer on a support, the elastomeric layer comprising a binder and also optionally further additive and auxiliary materials. Providing a mold can then comprise the following steps:
1) applying a liquid binder, optionally comprising additive and/or auxiliary materials, to a patterned surface, for example another mold or an original pattern,
2) curing the binder, for example by thermal curing, radiative curing or by allowing to age,
3) separating the mold thus obtainable and optionally applying it to a support, for example a metal plate or a metal cylinder.

One embodiment of the present invention proceeds by a liquid silicone being applied to a pattern, the silicone being allowed to age and thus cure and then stripping. The silicone film is then adhered to an aluminum support.

A preferred embodiment of the present invention provides a mold comprising a laser-engravable layer or a layer composite comprising a laser-engravable layer on a support, the laser-engravable layer comprising a binder and also, optionally, further additive and auxiliary materials. The laser-engravable layer is preferably also elastomeric.

In a preferred embodiment, the providing of a mold comprises the steps of:
1) providing a laser-engravable layer or a layer composite comprising a laser-engravable layer on a support, the laser-engravable layer comprising a binder and also, preferably, additive and auxiliary materials,
2) thermochemical, photochemical or actinic amplification of the laser-engravable layer,
3) engraving into the laser-engravable layer, using a laser, a surface structure corresponding to the surface structure of the surface-structured coating.

The laser-engravable layer, which is preferably elastomeric, or the layer composite can be and preferably are present on a support. Examples of suitable supports comprise woven fabrics and self-supporting films/sheets of polyethylene terephthalate (PET), polyethylene naphthalate (PEN), polybutylene terephthalate (PBT), polyethylene, polypropylene, polyamide or polycarbonate, preferably PET or PEN self-supporting films/sheets.

Useful supports likewise include papers and knits, for example of cellulose. As supports there may also be used conical or cylindrical sleeves of the materials mentioned. Also suitable for sleeves are glass fiber fabrics or composite materials comprising glass fibers and polymeric materials of construction. Suitable support materials further include metallic supports such as for example solid or fabric-shaped, sheetlike or cylindrical supports of aluminum, steel, magnetizable spring steel or other iron alloys.

In an embodiment of the present invention, the support may be coated with an adhesion-promoting layer to provide better adhesion of the laser-engravable layer. Another embodiment of the present invention requires no adhesion-promoting layer.

The laser-engravable layer comprises at least one binder, which may be a prepolymer which reacts in the course of a thermochemical amplification to form a polymer. Suitable binders can be selected according to the properties desired for the laser-engravable layer or the mold, for example with regard to hardness, elasticity or flexibility. Suitable binders can essentially be divided into 3 groups, without there being any intention to limit the binders thereto.

The first group comprises those binders which have ethylenically unsaturated groups. Ethylenically unsaturated groups are crosslinkable photochemically, thermochemically, by means of electron beams or by means of any desired combination thereof. In addition, mechanical amplification is possible by means of fillers. Such binders are for example those comprising 1,3-diene monomers such as isoprene or 1,3-butadiene in polymerized form. The ethylenically unsaturated group may either function as a chain building block of the polymer (1,4-incorporation), or it may be bonded to the polymer chain as a side group (1,2-incorporation). As examples there may be mentioned natural rubber, polybutadiene, polyisoprene, styrene-butadiene rubber, nitrile-butadiene rubber, acrylonitrile-butadiene-styrene (ABS) copolymer, butyl rubber, styrene-isoprene rubber, polychloroprene, polynorbornene rubber, ethylene-propylene-diene monomer (EPDM) rubber or polyurethane elastomers having ethylenically unsaturated groups.

Further examples comprise thermoplastic elastomeric block copolymers of alkenyl-aromatics and 1,3-dienes. The block copolymers may comprise either linear block copolymers or else radial block copolymers. Typically they are three-block copolymers of the A-B-A type, but they may also comprise two-block polymers of the A-B type, or those having a plurality of alternating elastomeric and thermoplastic blocks, for example A-B-A-B-A. Mixtures of two or more different block copolymers can also be used. Commercially available three-block copolymers frequently comprise certain proportions of two-block copolymers. Diene units may be 1,2- or 1,4-linked. Block copolymers of the styrene-butadiene type and also of the styrene-isoprene type can be used. They are commercially available under the name Kraton® for example. It is also possible to use thermoplastic elastomeric block copolymers having end blocks of styrene and a random styrene-butadiene middle block, which are available under the name Styroflex®.

Further examples of binders having ethylenically unsaturated groups comprise modified binders in which crosslinkable groups are introduced into the polymeric molecule through grafting reactions.

The second group comprises those binders which have functional groups. The functional groups are crosslinkable thermochemically, by means of electron beams, photochemically or by means of any desired combination thereof. In addition, mechanical amplification is possible by means of fillers. Examples of suitable functional groups comprise —Si(HR¹)O—, —Si(R¹R²)O—, —OH, —NH₂, —NHR¹, —COON, —COOR¹, —COHN², —O—C(O)NHR¹, —SO₃H or —CO—. Examples of binders comprise silicone elastomers, acrylate rubbers, ethylene-acrylate rubbers, ethylene-acrylic acid rubbers or ethylene-vinyl acetate rubbers and also their partially hydrolyzed derivatives, thermoplastic elastomeric polyurethanes, sulfonated polyethylenes or thermoplastic elastomeric polyesters. In the formulae, R¹ and—if present —R² are different or preferably the same and are each selected from organic groups and in particular C₁-C₆-alkyl.

One embodiment of the present invention comprises using binders having both ethylenically unsaturated groups and functional groups. Examples comprise addition-crosslinking silicone elastomers having functional groups and ethylenically unsaturated groups, copolymers of butadiene with (meth)acrylates, (meth)acrylic acid or acrylonitrile, and also copolymers or block copolymers of butadiene or isoprene with styrene derivatives having functional groups, examples being block copolymers of butadiene and 4-hydroxystyrene.

The third group of binders comprises those which have neither ethylenically unsaturated groups nor functional groups. There may be mentioned for example polyolefins or ethylene-propylene elastomers or products obtained by hydrogenation of diene units, for example SEBS rubbers.

Polymer layers comprising binders without ethylenically unsaturated or functional groups generally have to be amplified mechanically, with the aid of high-energy radiation or a combination thereof in order to permit optimum crisp structurability via laser.

It is also possible to use mixtures of two or more binders, in which case the two or more binders in any one mixture may all just come from one of the groups described or may come from two or all three groups. The possible combinations are only limited insofar as the suitability of the polymer layer for the laser-structuring operation and the negative-molding operation must not be adversely affected. It may be advantageous to use for example a mixture of at least one elastomeric binder having no functional groups with at least one further binder having functional groups or ethylenically unsaturated groups.

In one embodiment of the present invention, the proportion of binder or binders in the elastomeric layer or the particular laser-engravable layer is in the range from 30% by weight to 99% by weight based on the sum total of all the constituents of the particular elastomeric layer or the particular laser-engravable layer, preferably in the range from 40% to 95% by weight and most preferably in the range from 50% to 90% by weight.

In an embodiment of the present invention, polyurethane layer (C) is formed with the aid of a silicone mold. Silicone molds herein are molds prepared using at least one binder having at least one and preferably at least three O—Si(R¹R²)—O— groups per molecule, where the variables are each as defined above.

Optionally, the elastomeric layer or laser-engravable layer may comprise reactive low molecular weight or oligomeric compounds. Oligomeric compounds generally have a molecular weight of not more than 20 000 g/mol. Reactive low molecular weight and oligomeric compounds are hereinbelow simply referred to as monomers. Monomers may be added to increase the rate of photochemical or thermochemical crosslinking or of crosslinking via high-energy radiation, if desired. When binders from the first and second groups are used, the addition of monomers for acceleration is generally not absolutely essential. In the case of binders from the third group, the addition of monomers is generally advisable without being absolutely essential in every case.

Irrespective of the issue of crosslinking rate, monomers can also be used for controlling crosslink density. Depending on the identity and amount of low molecular weight compounds added, wider or narrower networks are obtained. Known ethylenically unsaturated monomers can be used first of all. The monomers should be substantially compatible with the binders and have at least one photochemically or thermochemically reactive group. They should not be volatile. Preferably, the boiling point of suitable monomers is at least 150° C. Of particular suitability are amides of acrylic acid or methacrylic acid with mono- or polyfunctional alcohols, amines, aminoalcohols or hydroxy ethers and hydroxy esters, styrene or substituted styrenes, esters of fumaric or maleic acid, or allyl compounds. Examples comprise n-butyl acrylate, 2-ethylhexyl acrylate, lauryl acrylate, 1,4-butanediol di(meth)acrylate, 1,6-hexanediol diacrylate, 1,6-hexanediol dimethacrylate, 1,9-nonanediol diacrylate, trimethylolpropane trimethacrylate, trimethylolpropane triacrylate, dipropylene glycol diacrylate, tripropylene glycol diacrylate, dioctyl fumarate, N-dodecylmaleimide and triallyl isocyanurate.

Monomers suitable for thermochemical amplification in particular comprise reactive low molecular weight silicones such as for example cyclic siloxanes, Si—H-functional siloxanes, siloxanes having alkoxy or ester groups, sulfur-containing siloxanes and silanes, dialcohols such as for example 1,4-butanediol, 1,6-hexanediol, 1,8-octanediol, 1,9-nonanediol, diamines such as for example 1,6-hexanediamine, 1,8-octanediamine, amino alcohols such as for example ethanolamine, diethanolamine, butylethanolamine, dicarboxylic acids such as for example 1,6-hexanedicarboxylic acid, terephthalic acid, maleic acid or fumaric acid.

It is also possible to use monomers having both ethylenically unsaturated groups and functional groups. As examples there may be mentioned w-hydroxyalkyl (meth)acrylates, such as for example ethylene glycol mono(meth)acrylate, 1,4-butanediol mono(meth)acrylate or 1,6-hexanediol mono(meth)acrylate.

It is of course also possible to use mixtures of different monomers, provided that the properties of the elastomeric layer are not adversely affected by the mixture. In general, the amount of added monomers is in the range from 0% to 40% by weight, based on the amount of all the constituents of the elastomeric layer or of the particular laser-engravable layer, preferably in the range from 1% to 20% by weight.

In one embodiment, one or more monomers may be used together with one or more catalysts. It is thus possible to accelerate silicone molds by addition of one or more acids or via organotin compounds to accelerate step 2) of the providing of the mold. Suitable organotin compounds can be: di-n-butyltin dilaurate, di-n-butyltin dioctanoate, di-n-butyltin di-2-ethylhexanoate, di-n-octyltin di-2-ethylhexanoate and di-n-butylbis-(1-oxoneodecyloxy)stannane.

The elastomeric layer or the laser-engravable layer may further comprise additive and auxiliary materials such as for example IR absorbers, dyes, dispersants, antistats, plasticizers or abrasive particles. The amount of such additive and auxiliary materials should generally not exceed 30% by weight, based on the amount of all the components of the elastomeric layer or of the particular laser-engravable layer.

The elastomeric layer or the laser-engravable layer may be constructed from a plurality of individual layers. These individual layers may be of the same material composition, of substantially the same material composition or of differing material composition. The thickness of the laser-engravable layer or of all individual layers together is generally between 0.1 and 10 mm and preferably in the range from 0.5 to 3 mm. The thickness can be suitably chosen depending on use-related and machine-related processing parameters of the laser-engraving operation and of the negative molding operation.

The elastomeric layer or the laser-engravable layer may optionally further comprise a top layer having a thickness of not more than 300 μm. The composition of such a top layer is choosable with regard to optimum engravability and mechanical stability, while the composition of the layer underneath is chosen with regard to optimum hardness or elasticity.

In one embodiment of the present invention, the top layer itself is laser-engravable or removable in the course of the laser-engraving operation together with the layer underneath. The top layer comprises at least one binder. It may further comprise an absorber for laser radiation or else monomers or auxiliaries.

In one embodiment of the present invention, the silicone mold comprises a silicone mold structured with the aid of laser engraving.

It is very particularly advantageous for the process according to the present invention to utilize thermoplastic elastomeric binders or silicone elastomers. When thermoplastic elastomeric binders are used, production is preferably effected by extrusion between a support film/sheet and a cover film/sheet or a cover element followed by calendering, as disclosed in EP-A 0 084 851 for flexographic printing elements for example. Even comparatively thick layers can be produced in a single operation in this way. Multilayered elements can be produced by coextrusion.

To structure the mold with the aid of laser engraving, it is preferable to amplify the laser-engravable layer before the laser-engraving operation by heating (thermochemically), by exposure to UV light (photochemically) or by exposure to high-energy radiation (actinically) or any desired combination thereof. Thereafter, the laser-engravable layer or the layer composite is applied to a cylindrical (temporary) support, for example of plastic, glass fiber-reinforced plastic, metal or foam, for example by means of adhesive tape, reduced pressure, clamping devices or magnetic force, and engraved as described above. Alternatively, the planar layer or the layer composite can also be engraved as described above. Optionally, the laser-engravable layer is washed using a rotary cylindrical washer or a continuous washer with a cleaning agent for removing engraving residues during the laser-engraving operation.

The mold can be produced in the manner described as a negative mold or as a positive mold.

In a first variant, the mold has a negative structure, so that the coating which is bondable to backing material is obtainable directly by application of a liquid plastics material to the surface of the mold and subsequent solidification of the polyurethane.

In a second variant, the mold has a positive structure, so that initially a negative mold is produced by negative molding from the laser-structured positive mold. The coating bondable to a sheetlike support can then be obtained from this negative mold by application of a liquid plastics material to the surface of the negative mold and subsequent solidification of the plastics material.

Preferably, structure elements having dimensions in the range from 10 to 500 μm are engraved into the mold. The structure elements may be in the form of elevations or depressions. Preferably, the structure elements have a simple geometric shape and are for example circles, ellipses, squares, rhombuses, triangles and stars. The structure elements may form a regular or irregular screen. Examples are a classic dot screen or a stochastic screen, for example a frequency-modulated screen.

In one embodiment of the present invention, the mold is structured by using a laser to cut wells into the mold which have an average depth in the range from 50 to 250 μm and a center-to-center spacing in the range from 50 to 250 μm.

For example, the mold can be engraved such that it has wells having a diameter in the range from 10 to 500 μm at the surface of the mold. The diameter at the surface of the mold is preferably in the range from 20 to 250 μm and more preferably 30-150 μm. The spacing of the wells can be for example in the range from 10 to 500 μm, preferably in the range from 20 to 200 μm and more preferably up to 80 μm.

In one embodiment of the present invention, the mold preferably has a surface fine structure as well as a surface coarse structure. Both coarse structure and fine structure can be produced by laser engraving. The fine structure can be for example a micro-roughness having a roughness amplitude in the range from 1 to 30 μm and a roughness frequency in the range from 0.5 to 30 μm. The dimensions of the micro-roughness are preferably in the range from 1 to 20 μm, more preferably in the range from 2 to 15 μm and more preferably in the range from 3 to 10 μm.

IR lasers in particular are suitable for laser engraving. However, it is also possible to use lasers having shorter wavelengths, provided the laser is of sufficient intensity. For example, a frequency-doubled (532 nm) or frequency-tripled (355 nm) Nd-YAG laser can be used, or else an excimer laser (248 nm for example). The laser-engraving operation may utilize for example a CO₂ laser having a wavelength of 10 640 nm. It is particularly preferable to use lasers having a wavelength in the range from 600 to 2000 nm. Nd-YAG lasers (1064 nm), IR diode lasers or solid-state lasers can be used for example. Nd/YAG lasers are particularly preferred. The image information to be engraved is transferred directly from the lay-out computer system to the laser apparatus. The lasers can be operated either continuously or in a pulsed mode.

The mold obtained can generally be used directly as produced. If desired, the mold obtained can additionally be cleaned. Such a cleaning step removes loosened but possibly still not completely detached layer constituents from the surface. In general, simply treating with water, water/surfactant, alcohols or inert organic cleaning agents which are preferably low-swelling will be sufficient.

In a further step, an aqueous formulation of polyurethane is applied to the mold. The applying may preferably be effected by spraying. The mold should have been heated when the formulation of polyurethane is applied, for example to temperatures of at least 80° C., preferably at least 90° C. The water from the aqueous formulation of polyurethane evaporates and forms the capillaries in the solidifying polyurethane layer.

Aqueous in connection with the polyurethane dispersion is to be understood as meaning that the polyurethane dispersion comprises water, but less than 5% by weight, based on the dispersion, preferably less than 1% by weight of organic solvent. It is particularly preferable for there to be no detectable volatile organic solvent. Volatile organic solvents herein are such organic solvents as have a boiling point of up to 200° C. at standard pressure.

The aqueous polyurethane dispersion can have a solids content in the range from 5% to 60% by weight, preferably in the range from 10% to 50% by weight and more preferably in the range from 25% to 45% by weight.

Polyurethanes (PUs) are common general knowledge, commercially available and consist in general of a soft phase of comparatively high molecular weight polyhydroxy compounds, for example of polycarbonate, polyester or polyether segments, and a urethane hard phase formed from low molecular weight chain extenders and di- or polyisocyanates.

Processes for preparing polyurethanes (PUs) are common general knowledge. In general, polyurethanes (PUs) are prepared by reaction of
(a) isocyanates, preferably diisocyanates, with
(b) isocyanate-reactive compounds, typically having a molecular weight (M_{w}) in the range from 500 to 10 000 g/mol, preferably in the range from 500 to 5000 g/mol and more preferably in the range from 800 to 3000 g/mol, and
(c) chain extenders having a molecular weight in the range from 50 to 499 g/mol optionally in the presence of
(d) catalysts
(e) and/or customary additive materials.

In what follows, the starting components and processes for preparing the preferred polyurethanes (PUs) will be described by way of example. The components (a), (b), (c) and also optionally (d) and/or (e) customarily used in the preparation of polyurethanes (PUs) will now be described by way of example:

As isocyanates (a) there may be used commonly known aliphatic, cycloaliphatic, araliphatic and/or aromatic isocyanates, examples being tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and/or 4,4′-, 2,4′- and 2,2′-dicyclohexylmethane diisocyanate, 2,2′-, 2,4′- and/or 4,4′-diphenylmethane diisocyanate (MDI), 1,5-naphthylene diisocyanate (NDI), 2,4- and/or 2,6-tolylene diisocyanate (TDI), diphenylmethane diisocyanate, 3,3′-dimethylbiphenyl diisocyanate, 1,2-diphenylethane diisocyanate and/or phenylene diisocyanate. Preference is given to using 4,4′-MDI. Preference is also given to aliphatic diisocyanates, in particular hexamethylene diisocyanate (HDI), and particular preference is given to aromatic diisocyanates such as 2,2′-, 2,4′- and/or 4,4′-diphenyl-methane diisocyanate (MDI) and mixtures of the aforementioned isomers.

As isocyanate-reactive compounds (b) there may be used the commonly known isocyanate-reactive compounds, examples being polyesterols, polyetherols and/or polycarbonate diols, which are customarily also subsumed under the term “polyols”, having molecular weights (Mw) in the range of 500 and 8000 g/mol, preferably in the range from 600 to 6000 g/mol, in particular in the range from 800 to 3000 g/mol, and preferably an average functionality of 1.8 to 2.3, preferably 1.9 to 2.2, in particular 2, with regard to isocyanates. Preference is given to using polyether polyols, for example those based on commonly known starter substances and customary alkylene oxides, for example ethylene oxide, 1,2-propylene oxide and/or 1,2-butylene oxide, preferably polyetherols based on polyoxytetramethylene (poly-THF), 1,2-propylene oxide and ethylene oxide. Polyetherols have the advantage of having a higher hydrolysis stability than polyesterols, and are preferably used as component (b), in particular for preparing soft polyurethanes polyurethane (PU1).

As polycarbonate diols there may be mentioned in particular aliphatic polycarbonate diols, for example 1,4-butanediol polycarbonate and 1,6-hexanediol polycarbonate.

As polyester diols there are to be mentioned those obtainable by polycondensation of at least one primary diol, preferably at least one primary aliphatic diol, for example ethylene glycol, 1,4-butanediol, 1,6-hexanediol, neopentyl glycol or more preferably 1,4-dihydroxymethylcyclohexane (as isomer mixture) or mixtures of at least two of the aforementioned diols, and at least one, preferably at least two dicarboxylic acids or their anhydrides. Preferred dicarboxylic acids are aliphatic dicarboxylic acids such as adipic acid, glutaric acid, succinic acid and aromatic dicarboxylic acids such as for example phthalic acid and particularly isophthalic acid.

Polyetherols are preferably prepared by addition of alkylene oxides, in particular ethylene oxide, propylene oxide and mixtures thereof, onto diols such as for example ethylene glycol, 1,2-propylene glycol, 1,2-butylene glycol, 1,4-butanediol, 1,3-propanediol, or onto triols such as for example glycerol, in the presence of high-activity catalysts. Such high-activity catalysts are for example cesium hydroxide and dimetal cyanide catalysts, also known as DMC catalysts. Zinc hexacyanocobaltate is a frequently employed DMC catalyst. The DMC catalyst can be left in the polyetherol after the reaction, but preferably it is removed, for example by sedimentation or filtration.

Mixtures of various polyols can also be used instead of just one polyol.

To improve dispersibility, isocyanate-reactive compounds (b) may also include a proportion of one or more diols or diamines having a carboxylic acid group or sulfonic acid group (b′), in particular alkali metal or ammonium salts of 1,1-dimethylolbutanoic acid, 1,1-dimethylolpropionic acid or

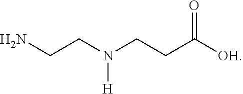

Useful chain extenders (c) include commonly known aliphatic, araliphatic, aromatic and/or cycloaliphatic compounds having a molecular weight in the range from 50 to 499 g/mol and at least two functional groups, preferably compounds having exactly two functional groups per molecule, examples being diamines and/or alkanediols having 2 to 10 carbon atoms in the alkylene radical, in particular 1,3-propanediol, 1,4-butanediol, 1,6-hexanediol and/or di-, tri-, tetra-, penta-, hexa-, hepta-, octa-, nona- and/or decaalkylene glycols having 3 to 8 carbon atoms per molecule, preferably the corresponding oligo- and/or polypropylene glycols, and mixtures of chain extenders (c) can also be used.

It is particularly preferable for components (a) to (c) to comprise difunctional compounds, i.e., diisocyanates (a), difunctional polyols, preferably polyetherols (b) and difunctional chain extenders, preferably diols.

Useful catalysts (d) to speed in particular the reaction between the NCO groups of the diisocyanates (a) and the hydroxyl groups of the building block components (b) and (c) are customary tertiary amines, for example triethylamine, dimethylcyclohexylamine, N-methylmorpholine, N,N′-dimethylpiperazine, 2-(dimethylaminoethoxy)ethanol, diazabicyclo[2.2.2]octane (DABCO) and similar tertiary amines, and also in particular organic metal compounds such as titanic esters, iron compounds such as for example iron(III) acetylacetonate, tin compounds, for example tin diacetate, tin dioctoate, tin dilaurate or the tin dialkyl salts of aliphatic carboxylic acids such as dibutyltin diacetate, dibutyltin dilaurate or the like. The catalysts are typically used in amounts of 0.0001 to 0.1 part by weight per 100 parts by weight of component (b).

As well as catalyst (d), auxiliaries and/or additives (e) can also be added to the components (a) to (c). There may be mentioned for example blowing agents, antiblocking agents, surface-active substances, fillers, for example fillers based on nanoparticles, in particular fillers based on CaCO₃, nucleators, glidants, dyes and pigments, antioxidants, for example against hydrolysis, light, heat or discoloration, inorganic and/or organic fillers, reinforcing agents and plasticizers, metal deactivators. In a preferred embodiment, component (e) also includes hydrolysis stabilizers such as for example polymeric and low molecular carbodiimides. The soft polyurethane preferably comprises triazole and/or triazole derivative and antioxidants in an amount of 0.1% to 5% by weight based on the total weight of the soft polyurethane in question. Useful antioxidants are generally substances that inhibit or prevent unwanted oxidative processes in the plastics material to be protected. In general, antioxidants are commercially available. Examples of antioxidants are sterically hindered phenols, aromatic amines, thiosynergists, organophosphorus compounds of trivalent phosphorus and hindered amine light stabilizers. Examples of sterically hindered phenols are to be found in Plastics Additive Handbook, 5th edition, H. Zweifel, ed., Hanser Publishers, Munich, 2001 ([1]), pages 98-107 and page 116-page 121. Examples of aromatic amines are to be found in [1] pages 107-108. Examples of thiosynergists are given in [1], pages 104-105 and pages 112-113. Examples of phosphites are to be found in [1], pages 109-112. Examples of hindered amine light stabilizers are given in [1], pages 123-136. Phenolic antioxidants are preferred for use in the antioxidant mixture. In a preferred embodiment, the antioxidants, in particular the phenolic antioxidants, have a molar mass of greater than 350 g/mol, more preferably greater than 700 g/mol and a maximum molar mass (M_{w}) of not more than 10 000 g/mol, preferably up to not more than 3000 g/mol. They further preferably have a melting point of not more than 180° C. It is further preferable to use antioxidants that are amorphous or liquid. Mixtures of two or more antioxidants can likewise be used as component (e).

As well as the specified components (a), (b) and (c) and optionally (d) and (e), chain regulators (chain-terminating agents), customarily having a molecular weight of 31 to 3000 g/mol, can also be used. Such chain regulators are compounds which have only one isocyanate-reactive functional group, examples being monofunctional alcohols, monofunctional amines and/or monofunctional polyols. Such chain regulators make it possible to adjust flow behavior, in particular in the case of soft polyurethanes, to specific values. Chain regulators can generally be used in an amount of 0 to 5 parts and preferably 0.1 to 1 part by weight, based on 100 parts by weight of component (b), and by definition come within component (c).

As well as the specified components (a), (b) and (c) and optionally (d) and (e), it is also possible to use crosslinkers having two or more isocyanate-reactive groups toward the end of the polyurethane-forming reaction, for example hydrazine hydrate.

To adjust the hardness of polyurethane (PU), the components (b) and (c) can be chosen within relatively wide molar ratios. Useful are molar ratios of component (b) to total chain extenders (c) in the range from 10:1 to 1:10, and in particular in the range from 1:1 to 1:4, the hardness of the soft polyurethanes increasing with increasing (c) content. The reaction to produce polyurethane (PU) can be carried out at an index in the range from 0.8 to 1.4:1, preferably at an index in the range from 0.9 to 1.2:1 and more preferably at an index in the range from 1.05 to 1.2:1. The index is defined by the ratio of all the isocyanate groups of component (a) used in the reaction to the isocyanate-reactive groups, i.e., the active hydrogens, of components (b) and optionally (c) and optionally monofunctional isocyanate-reactive components as chain-terminating agents such as monoalcohols for example.

Polyurethane (PU) can be prepared by conventional processes in a continuous manner, for example by the one-shot or the prepolymer process, or batchwise by the conventional prepolymer operation. In these processes, the reactant components (a), (b), (c) and optionally (d) and/or (e) can be mixed in succession or simultaneously, and the reaction ensues immediately.

Polyurethane (PU) can be dispersed in water in a conventional manner, for example by dissolving polyurethane (PU) in acetone or preparing it as a solution in acetone, admixing the solution with water and then removing the acetone, for example distillatively. In one variant, polyurethane (PU) is prepared as a solution in N-methyl-pyrrolidone or N-ethylpyrrolidone, admixed with water and the N-methylpyrrolidone or N-ethylpyrrolidone is removed.

In an embodiment of the present invention, aqueous dispersions comprise two different polyurethanes polyurethane (PU1) and polyurethane (PU2), of which polyurethane (PU1) is a so-called soft polyurethane which is constructed as described above for polyurethane (PU), and at least one hard polyurethane (PU2).

Hard polyurethane (PU2) can in principle be prepared similarly to soft polyurethane (PU1), but other isocyanate-reactive compounds (b) or other mixtures of isocyanate-reactive compounds (b), herein also referred to as isocyanate-reactive compounds (b2) or in short compound (b2), are used.

Examples of compounds (b2) are in particular 1,4-butanediol, 1,6-hexanediol and neopentyl glycol, either mixed with each other or mixed with polyethylene glycol.

In one version of the present invention, diisocyanate (a) and polyurethane (PU2) are each mixtures of diisocyanates, for example mixtures of HDI and IPDI, larger proportions of IPDI being chosen for the preparation of hard polyurethane (PU2) than for the preparation of soft polyurethane (PU1).

In one embodiment of the present invention, polyurethane (PU2) has a Shore A hardness in the range from above 60 to not more than 100, the Shore A hardness being determined in accordance with German standard specification DIN 53505 after 3s.

In one embodiment of the present invention, polyurethane (PU) has an average particle diameter in the range from 100 to 300 nm and preferably in the range from 120 to 150 nm, determined by laser light scattering.

In one embodiment of the present invention, soft polyurethane (PU1) has an average particle diameter in the range from 100 to 300 nm and preferably in the range from 120 to 150 nm, determined by laser light scattering.

In one embodiment of the present invention, polyurethane (PU2) has an average particle diameter in the range from 100 to 300 nm and preferably in the range from 120 to 150 nm, determined by laser light scattering.

The aqueous polyurethane dispersion may further comprise at least one curative, which may also be referred to as a crosslinker. Compounds are useful as a curative which are capable of crosslinking a plurality of polyurethane molecules together, for example on thermal activation. Of particular suitability are crosslinkers based on trimeric diisocyanates, in particular based on aliphatic diisocyanates such as hexamethylene diisocyanate. Very particular preference is given to crosslinkers as described in WO 2008/113755.

Aqueous polyurethane dispersions may comprise further constituents, for example (f) a silicone compound having reactive groups, herein also referred to as silicone compound (f).

Examples of reactive groups in connection with silicone compounds (f) are for example carboxylic acid groups, carboxylic acid derivatives such as for example methyl carboxylate or carboxylic anhydrides, in particular succinic anhydride groups, and more preferably carboxylic acid groups.

Examples of reactive groups further include primary and secondary amino groups, for example NH(iso-C₃H₇) groups, NH(n-C₃H₇) groups, NH(cyclo-C₆H₁₁) groups and NH(n-C₄H₉) groups, in particular NH(C₂H₅) groups and NH(CH₃) groups, and most preferably NH₂ groups.

Preference is further given to aminoalkylamino groups such as for example —NH—CH₂—CH₂—NH₂ groups, —NH—CH₂—CH₂-CH₂—NH₂ groups, —NH—CH₂—CH₂—NH(C₂H₅) groups, —NH—CH₂—CH₂—CH₂—NH(C₂H₅) groups, —NH—CH₂—CH₂—NH(CH₃) groups, —NH—CH₂—CH₂-CH₂—NH(CH₃) groups.

The reactive group or groups are attached to silicone compound (f) either directly or preferably via a spacer A². A² is selected from arylene, unsubstituted or substituted with one to four C₁-C₄-alkyl groups, alkylene and cycloalkylene such as for example 1,4-cyclohexylene. Preferred spacers A² are phenylene, in particular para-phenylene, also tolylene, in particular para-tolylene, and C₂-C₁₈-alkylene such as for example ethylene (CH₂CH₂), also —(CH₂)₃—, —(CH₂)₄—, —(CH₂)₅—, —(CH₂)₆—, —(CH₂)₈—, —(CH₂)₁₀—, —(CH₂)₁₂—, —(CH₂)₁₄-, —(CH₂)₁₆— and —(CH₂)₁₈—.

In addition to the reactive groups, silicone compound (f) comprises non-reactive groups, in particular di-C₁-C₁₀-alkyl-SiO₂ groups or phenyl-C₁-C₁₀-alkyl-SiO₂ groups, in particular dimethyl-SiO₂ groups, and optionally one or more Si(CH₃)₂—OH groups or Si(CH₃)₃ groups.

Very particular preference is given to silicone compounds having reactive groups (f), as described in WO 2008/113755.

In an embodiment of the present invention, aqueous polyurethane dispersion further comprises

a polydi-C₁-C₄-alkylsiloxane (g) having neither amino groups nor COOH groups, preferably a polydimethylsiloxane, herein also referred to in brief as polydialkylsiloxane (g) or polydimethylsiloxane (g).

The C₁-C₄-alkyl in polydialkylsiloxane (g) may be different or preferably the same and selected from methyl, ethyl, n-propyl, isopropyl, n-butyl, isobutyl, sec-butyl and tert-butyl, of which unbranched C₁-C₄-alkyl is preferred and methyl is particularly preferred.

Very particular preference is given to polydialkylsiloxanes (g) and particularly polydimethylsiloxanes (g), as described in WO 2008/113755.

In one embodiment of the present invention, aqueous polyurethane dispersion comprises

altogether from 20% to 30% by weight of polyurethane (PU), or altogether from 20% to 30% by weight of polyurethanes (PU1) and (PU2),
optionally from 1% to 10%, preferably 2% to 5% by weight of curative, optionally from 1% to 10% by weight of silicone compound (f), from zero to 10%, preferably 0.5% to 5% by weight of polydialkylsiloxane (g).

In one embodiment of the present invention, aqueous polyurethane dispersion comprises

from 10% to 30% by weight of soft polyurethane (PU1) and
from zero to 20% by weight of hard polyurethane (PU2).

In one embodiment of the present invention, aqueous polyurethane dispersion has a solids content of altogether 5% to 60% by weight, preferably 10% to 50% by weight and more preferably 25% to 45% by weight.

These weight % ages each apply to the active or solid ingredient and are based on the total aqueous dispersion of the present invention. The remainder ad 100% by weight is preferably continuous phase, for example water or a mixture of one or more organic solvents and water.

In an embodiment of the present invention, aqueous polyurethane dispersion comprises at least one additive (h) selected from pigments, antilusterants, light stabilizers, antistats, antisoil, anticreak, thickening agents, in particular thickening agents based on polyurethanes, and microballoons.

In an embodiment of the present invention, aqueous polyurethane dispersion comprises all together up to 20% by weight of additives (h).

Aqueous polyurethane dispersion may also comprise one or more organic solvents. Suitable organic solvents are for example alcohols such as ethanol or isopropanol and in particular glycols, diglycols, triglycols or tetraglycols and doubly or preferably singly C₁-C₄-alkyl etherified glycols, diglycols, triglycols or tetraglycols. Examples of suitable organic solvents are ethylene glycol, propylene glycol, butylene glycol, diethylene glycol, triethylene glycol, tetraethylene glycol, dipropylene glycol, 1,2-dimethoxyethane, methyltriethylene glycol (“methyltriglycol”) and triethylene glycol n-butyl ether (“butyltriglycol”).

The invention is further elucidated by working examples.

### WORKING EXAMPLES

### I. Production of Starting Materials

### I.1 Production of an Aqueous Polyurethane Dispersion Disp. 1

The following were mixed in a stirred vessel:

7% by weight of an aqueous dispersion (particle diameter: 125 nm, solids content: 40%) of a soft polyurethane (PU1.1) prepared from hexamethylene diisocyanate (a1.1) and isophorone diisocyanate (a1.2) in a weight ratio of 13:10 as diisocyanates and as diols, a polyester diol (b1.1) having a molecular weight M_{w} of 800 g/mol, prepared by polycondensation of isophthalic acid, adipic acid and 1,4-dihydroxymethylcyclohexane (isomer mixture) in a molar ratio of 1:1:2, 5% by weight of 1,4-butanediol (b1.2) and also 3% by weight of monomethylated polyethylene glycol (c.1) and also 3% by weight of H₂N—CH₂CH₂—NH—CH₂CH₂—COOH, % by weight all based on polyester diol (b1.1), softening point of soft polyurethane (PU1.1): 62° C., softening starts at 55° C., Shore A hardness 54,
65% by weight of an aqueous dispersion (particle diameter: 150 nm) of a hard polyurethane (PU2.2), obtainable by reaction of isophorone diisocyanate (a1.2), 1,4-butanediol, 1,1-dimethylolpropionic acid, hydrazine hydrate and polypropylene glycol having a molecular weight M_{w} of 4200 g/mol, softening point of 195° C., Shore A hardness 86,
3.5% by weight of a 70% by weight solution (in propylene carbonate) of crosslinker (V.1),

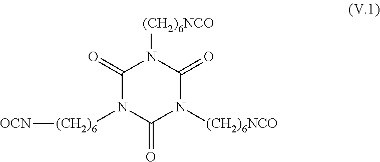

6% by weight of a 65% by weight aqueous dispersion of the silicone compound according to Example 2 of EP-A 0 738 747 (f.1)
2% by weight of carbon black,
0.5% by weight of a thickening agent based on polyurethane,
1% by weight of microballoons of polyvinylidene chloride, filled with isobutane, diameter 20 μm, commercially obtainable for example as Expancel® from Akzo Nobel.

This gave an aqueous dispersion Disp. 1 having a solids content of 35% and a kinematic viscosity of 25 seconds at 23° C., determined in accordance with DIN EN ISO 2431, as of May 1996.

### I.2 Production of an Aqueous Formulation Disp. 2

The following were mixed in a stirred vessel:

7% by weight of an aqueous dispersion (particle diameter: 125 nm, solids content: 40%) of a soft polyurethane (PU1.1) prepared from hexamethylene diisocyanate (a1.1) and isophorone diisocyanate (a1.2) in a weight ratio of 13:10 as diisocyanates and as diols, a polyester diol (b1.1) having a molecular weight M_{w} of 800 g/mol, prepared by polycondensation of isophthalic acid, adipic acid and 1,4-dihydroxymethylcyclohexane (isomer mixture) in a molar ratio of 1:1:2, 5% by weight of 1,4-butanediol (b1.2), 3% by weight of monomethylated polyethylene glycol (c.1) and also 3% by weight of H₂N—CH₂CH₂—NH—CH₂CH₂—COOH, % by weight all based on polyester diol (b1.1), softening point of 62° C., softening starts at 55° C., Shore A hardness 54,
65% by weight of an aqueous dispersion (particle diameter: 150 nm) of a hard polyurethane (a2.2), obtainable by reaction of isophorone diisocyanate (a1.2), 1,4-butanediol (PU1.2), 1,1-dimethylolpropionic acid, hydrazine hydrate and polypropylene glycol having a molecular weight M_{w} of 4200 g/mol (b1.3), polyurethane (PU2.2) had a softening point of 195° C., Shore A hardness 90,
3.5% by weight of a 70% by weight solution (in propylene carbonate) of compound (V.1),
NCO content 12%,
2% by weight of carbon black.

This gave a polyurethane dispersion Disp. 2 having a solids content of 35% and a kinematic viscosity of 25 seconds at 23° C., determined in accordance with DIN EN ISO 2431, as of May 1996.

### II. Production of a Mold

A liquid silicone was poured onto a surface having the pattern of full grain calf leather. The silicone was cured by adding a solution of di-n-butylbis(1-oxoneodecyloxy)-stannane as 25% by weight solution in tetraethoxysilane as an acidic curative to obtain a silicone rubber layer 2 mm in thickness on average, which served as the mold. The mold was adhered onto a 1.5 mm thick aluminum support.

### III. Application of Aqueous Polyurethane Dispersions onto Mold from II

The mold from II. was placed on a heatable surface and heated to 91° C. Disp. 1 was then sprayed onto it through a spray nozzle, at 88 g/m² (wet). No air was admixed during application, which was done with a spray nozzle having a diameter of 0.46 mm, at a pressure of 65 bar. This was followed by solidification at 91° C. until the surface was no longer tacky.

The spray nozzle was located 20 cm above the surface passing underneath it, and could be moved in the transport direction of the surface, and moved transversely to the transport direction of the surface. The surface took about 14 seconds to pass the spray nozzle and had a temperature of 59° C. After being exposed for about two minutes to a stream of dry hot air at 85° C., the polyurethane film thus produced, which had a netlike appearance, was almost water-free.

In an analogous arrangement, Disp. 2 was immediately thereafter applied to the mold thus coated, as bonding layer at 50 g/m² wet, and subsequently allowed to dry.

This gave a mold coated with polyurethane film and bonding layer.

An air-permeable polyurethane coagulate applied to a backing textile and having a layer thickness of 1 mm is sprayed with Disp. 2 at 30 g/m² (wet). The material thus sprayed was allowed to dry for several minutes.

### IV. Production of Membranes

### IV.1 Production of a Membrane M.1

Subsequently, the backing material is laid with the sprayed side onto the still warm bonding layer, which is present on the mold together with polyurethane film, and compressed in a press at 4 bar and 110° C. for 15 seconds. Subsequently, the resulting membrane M.1 was removed from the press and demolded.

### IV.2 Production of Membrane M.2

A silicone mold similarly to the mold from II, with the inverse surficial texture of a calf leather grain and the three-dimensional shape of a dashboard, in which there are cutouts for various instruments but no vent slots, is—in a manner similar to Example III heated to 100° C. and sprayed with Disp. 2. After a polyurethane layer has formed, it is sprayed on the reverse side with a suitable 2-component mixture composed of a polyol and an aromatic isocyanate, which are only mixed immediately before application, and form a 1 mm thick layer of a flexible PU foam on the reverse side of the polyurethane layer to obtain membrane M.2.

### V. Application to a Dashboard

### V.1 Application of M.1

The membrane M.1 obtained according to IV is uniformly adhered to the blank of an automotive dashboard. To obtain pleasant aesthetics, the blank is produced without vent slots, merely with cutouts for various instruments and switches. Instead, an air stream is routed through rear passageways to the reverse side of membrane M.1, as a result of which a pleasant climate is produced in the interior of the vehicle, without a fast air stream being noticeable.

### V.2 Application of M.2

The reverse side of M.2 is sprayed with a PU compact material having a thickness of 7.5 mm while leaving major cutouts for supplying air from behind. The layered construction thus obtained is installed in an automobile as a dashboard at the intended location, and is able to perform the air-conditioning functions described under Example V.1.

1. An article, having at least one opening wherethrough an air stream is directed, said opening being covered on a face side by a visually appealing air-permeable or breathable membrane wherethrough the gas stream passes, said membrane comprising two or more layers, one of which layers is a polyurethane layer which comprises:
at least one polyurethane;
has an average thickness in the range from 15 to 300 μm; and
exhibits patterning.

2. The article of claim 1, comprising a constituent part of a vehicle.

3. The article of claim 1, wherein at least one of said at least one opening is covered by said membrane such that, when viewed from said face side, it is not recognizable as an opening in that the membrane is placed over the at least one opening openings partially or completely.

4. The article of claim 1, wherein said membrane comprises as a second layer at least one backing material.

5. The article of claim 4, wherein said backing material is at least one material selected from the group consisting of textile, leather, artificial leather, and an open-cell foamed plastic.

6. The article of claim 1, in the form of cabin interior lining of a ship or airplane, or a dashboard of a motor vehicle, airplane, train, or water vehicle.

7. The article of claim 1, in the form of an interior part of a building.

8. The article of claim 1, comprising an air conditioning system, a heating system, or a fan.

9. The article of claim 6, wherein said membrane covers said at least one opening and some or all of said cabin interior lining of said ship or airplane, or of said dashboard of a motor vehicle, airplane, water vehicle, or train.

10. A process for producing the article of claim 1, comprising
(A) producing a porous polyurethane layer exhibiting patterning with a mold;
(B) fixing said polyurethane layer to a backing material; and
(C) covering at least one opening in the article.

11. The process of claim 10 wherein said fixing in (b) is effected by applying at least one bonding layer to at least one selected from the group consisting of said polyurethane layer and said backing material.

12. The article of claim 2, wherein at least one of said at least one opening is covered by said membrane such that, when viewed from said face side, it is not recognizable as an opening in that the membrane is placed over the at least one opening partially or completely.

13. The article of claim 2, wherein said membrane comprises as a second layer at least one backing material.

14. The article of claim 3, wherein said membrane comprises as a second layer at least one backing material.

15. The article of claim 1, wherein the membrane has a water vapor transmission rate of 1.5 mg/cm²·h, as measured by DIN 53333.

16. The article of claim 1, wherein the polyurethane layer has a thickness in a range of 20 to 150 μm.

17. The article of claim 1, wherein the polyurethane layer has a thickness in a range of 25 to 80 μm.
